(19) United States
(12) Patent Application Publication
(10) Pub. No.: US 2005/0025463 A1
(43) Pub. Date: Feb. 3, 2005

(54) Method and apparatus for creating multiple unique copies of content

(76) Inventors: Jeffrey Adam Bloom, West Windsor, NJ (US); Michael Anthony Isnardi, Plainsboro, NJ (US); Christos Alkiviadis Polyzois, Lawrenceville, NJ (US); Robert Norman Hurst JR., Hopewell, NJ (US); Michael Tinker, Yardley, PA (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 10/872,959

(22) Filed: Jun. 21, 2004

Related U.S. Application Data
(60) Provisional application No. 60/480,307, filed on Jun. 20, 2003.
(60) Provisional application No. 60/515,144, filed on Oct. 28, 2003.

(51) Int. Cl. H04N 5/781

(52) U.S. Cl. 386/96; 386/125

(57) ABSTRACT

A method and apparatus for creating multiple unique copies of content is disclosed. In one embodiment, at least two content versions are provided. The at least two content versions are alternated in order to provide uniquely marked content. In another embodiment, a plurality of content versions are provided. Content is unlocked in accordance with a keyset. In another embodiment, a content stream having a plurality of segments is provided. One or more segments are selected from the content stream in accordance with a keyset.

### CROSS-REFERENCE TO RELATED APPLICATIONS

This application claims benefit of U.S. provisional patent application Ser. No. 60/480,307, filed Jun. 20, 2003 and 60/515,144, filed Oct. 28, 2003, which are herein incorporated by reference.

### BACKGROUND OF THE INVENTION

In any communications medium, one may want to send different copies of content to different receivers. This may be useful, for example, for forensics when copies have been stolen. If the copy that has been stolen can be uniquely identified, then the circumstances of the theft can be more easily narrowed down. For example, if each movie shown in a theatre could be uniquely watermarked, it would be possible to identify the theatre from which a pirated copy was taken. This is of particular importance in the movie industry because piracy amounts to several billion dollars a year worldwide. Then, if a movie were stolen, at least the point of theft could be easily determined by looking at the pirated copies. In order for this unique watermarking to be useful, it must be done in a secure way such that the content owner, not the distributor or exhibitor, can guarantee the uniqueness of the copy. If someone other than the content owner, e.g., the exhibitor, can control the watermark, then they can steal the copy without leaving a watermarked trail.

Therefore, there is a need in the art to provide uniquely marked copies of content in the compressed and uncompressed domain.

### SUMMARY OF THE INVENTION

The present invention generally relates to a method and apparatus to provide uniquely marked copies of content in the compressed and uncompressed domain. In one embodiment, at least two content versions are provided. The at least two content versions are alternated in order to provide uniquely marked content.

In another embodiment, a plurality of content versions are provided. Content is unlocked in accordance with a keyset.

In another embodiment, a content stream having a plurality of segments is provided. One or more segments are selected from the content stream in accordance with a keyset.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a diagram in accordance with one embodiment of the present invention;

FIG. 2 illustrates a method and apparatus for creating multiple unique copies of content in accordance with one embodiment of the present invention;

FIG. 3 illustrates a method and apparatus for providing the inputs to FIG. 2 in accordance with one embodiment of the present invention;

FIG. 4 illustrates a method and apparatus for providing the inputs to FIG. 2 in accordance with one embodiment of the present invention;

FIG. 5 illustrates a method and apparatus for providing the inputs to FIG. 2 in accordance with one embodiment of the present invention;

FIG. 6 illustrates a method and apparatus for providing the inputs to FIG. 2 in accordance with one embodiment of the present invention;

FIG. 7 illustrates a method and apparatus for providing the inputs to FIG. 2 in accordance with one embodiment of the present invention;

FIG. 8 illustrates an apparatus in accordance with one embodiment of the present invention;

FIG. 9 illustrates a data file in accordance with one embodiment of the present invention;

FIG. 10 illustrates a diagram in accordance with one embodiment of the present invention;

FIG. 11 illustrates bitstreams in accordance with one embodiment of the present invention;

FIG. 12 illustrates keysets in accordance with one embodiment of the present invention;

FIG. 13 illustrates decoded content in accordance with one embodiment of the present invention;

FIG. 14 illustrates a diagram in accordance with one embodiment of the present invention;

FIG. 15 illustrates bitstreams in accordance with one embodiment of the present invention;

FIG. 16 illustrates a bitstream in accordance with one embodiment of the present invention;

FIG. 17 illustrates a bitstream, keysets, and decoded content in accordance with one embodiment of the present invention;

FIG. 18 illustrates a bitstream, keysets, and decoded content in accordance with one embodiment of the present invention; and

FIG. 19 illustrates a block diagram of an image processing device or system in accordance with one embodiment of the present invention.

### DETAILED DESCRIPTION

The present invention generally relates to uniquely marking content. Watermarking may occur in the compressed domain or watermarking may be applied to uncompressed content. One having skill in the art would understand that the marking techniques disclosed herein could be applied to video and/or audio content.

Assuming for simplicity that watermark carriers do not overlap in time, i.e., each frame contributes to at most one watermark carrier, which can be modulated to carry a single bit of payload (0 or 1). Results can be generalized to non-binary modulation and also to carriers overlapping in space and/or time. Let Uᵢ be the i-th frame of the unmarked copy and let Mᵢⱼ be the i-th frame of the j-th marked copy. Then marking can be viewed as the combination of two mathematical operators:
Mᵢⱼ=embed(Uᵢ, select ᵢⱼ(0,1))

The function select ᵢⱼ(a,b) returns its first argument if the j-th marked copy should contain a 0 payload in the i-th frame and its second argument if it should contain a 1. The function embed(F,m) embeds a watermark carrier modulated for payload m in frame F.

Since embedding distributes over selection, the above formula can be rewritten as:
Mᵢⱼ=select ᵢⱼ(embed(Uᵢ,0), embed(Uᵢ,1))
Note that the original formula contains one (computationally expensive) embedding operation per marked copy per frame, while the second formula contains two such embedding operations. At first glance, it would appear that the first formula is more efficient. However, note that the embeddings in the second formula are independent of the particular marked copy. Thus, one would need two embeddings per marked frame whether one produces one marked copy or a million marked copies. In the case of non-binary modulation and/or carriers overlapping in time and/or space, the above discussion holds if the select function has an appropriate arity and returns one of all possible combinations of payloads and if the embed function takes a vector as its second argument rather than a single number. For example, if there are at most k binary carriers overlapping in time, the select function must have an arity of 2^{k} and the embed operation must take as second argument a vector of dimension k.

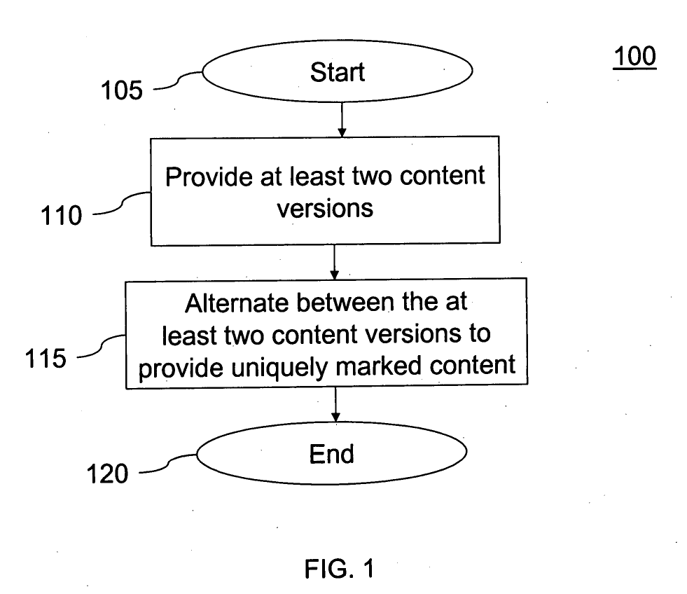

The above conclusions lead to a method to create marked copies. FIG. 1 illustrates a diagram in accordance with a method 100 of the present invention. Method 100 starts in step 105 and proceeds to step 110. In step 110 at least two content versions are provided.

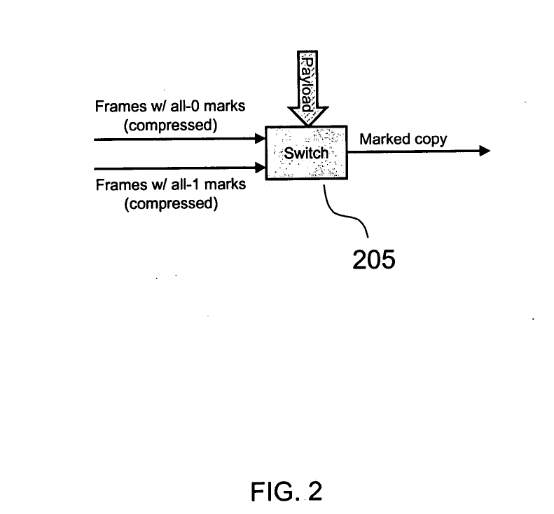

In one embodiment, the marked copies are compressed. The present invention discloses several methods to create two compressed marked copies (all-0s and all-1s) shown as inputs in FIG. 2, from which all individually marked copies can be assembled.

Care must be taken to ensure that switching from the all-0s sequence to the all-1s sequence is feasible. There are many ways to achieve this. One possible way is to ensure that watermark carriers are always separated by at least one I-frame and always effect switching at one of the I-frames that separates the carriers.

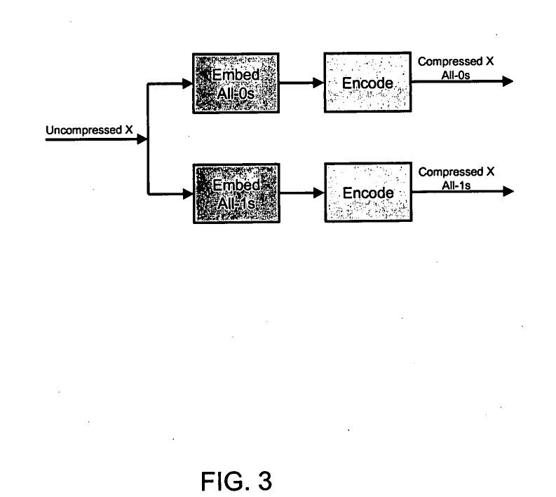

In one embodiment, one copy is marked by embedding all-0s in the pixel domain and another copy by embedding all-1s in the pixel domain. Each copy is compressed separately. The resulting compressed files should be similar enough to allow multiplexing of frames from either copy, because the differences introduced by watermarking are relatively small. The compatibility of the two versions can be verified, but it cannot be guaranteed. The approach is illustrated in FIG. 3.

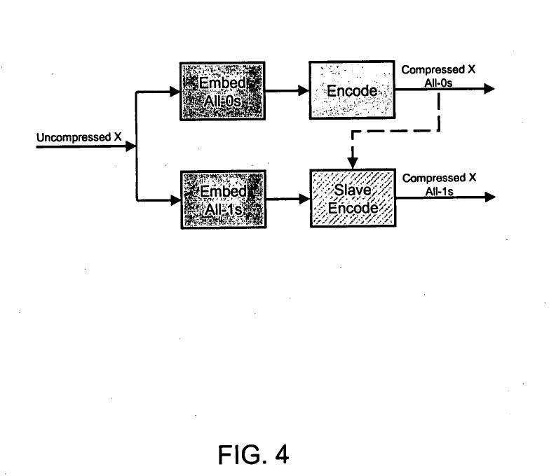

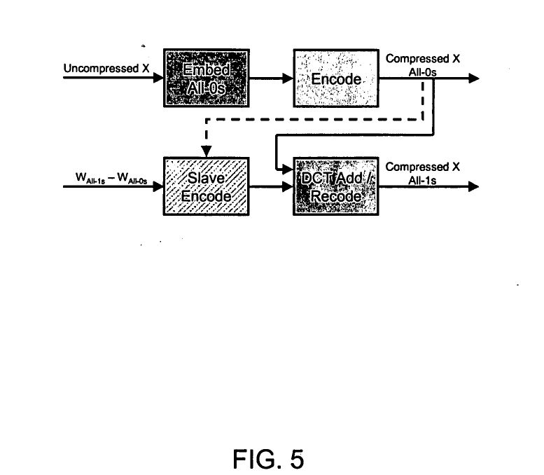

In one embodiment, one copy is marked (e.g., by embedding all-0s in the pixel domain) and compressed. A slave encoder that mimics all the encoding decisions of the original encoder is used and the method proceeds in either of the following ways: 1) Mark the uncompressed copy with all-1s in the pixel domain and feed it into the slave encoder, which creates a compressed all-1s marked copy compatible with the all-0s copy created by the master encoder. This approach is illustrated in FIG. 4; or 2) Feed the difference signal between the all-1s watermark sequence and the all-0s watermark sequence into the slave encoder and combine the resulting compressed sequence with the all-0s marked compressed sequence using an adder/recoder technique. Essentially, (X+Wₐₗₗ_{_{—}}₀)+(Wₐₗₗ_{_{—}}₁−Wₐₗₗ_{_{—}}₀)=X+Wₐₗₗ_{_{—}}₁. Where X comprises compressed content and W comprises a watermark sequence. The result is a compressed all-1s marked copy compatible with the all-0s copy created by the master encoder. The approach is illustrated in FIG. 5.

In the slave-encode once method, compatibility can be guaranteed and the content need be encoded only once. This is important, since human intervention may be required.

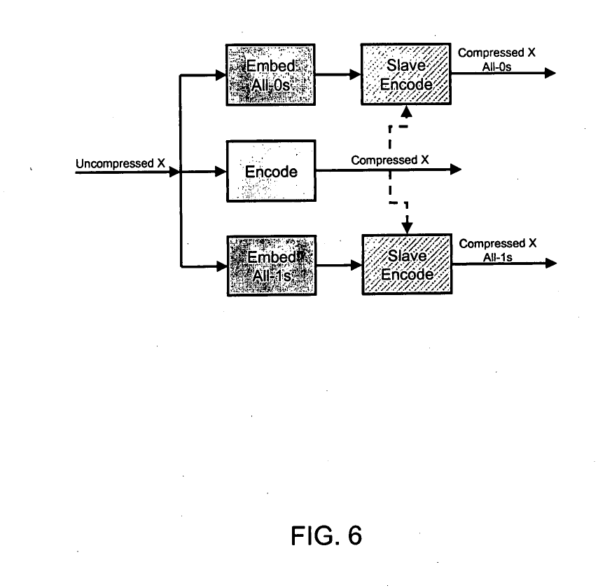

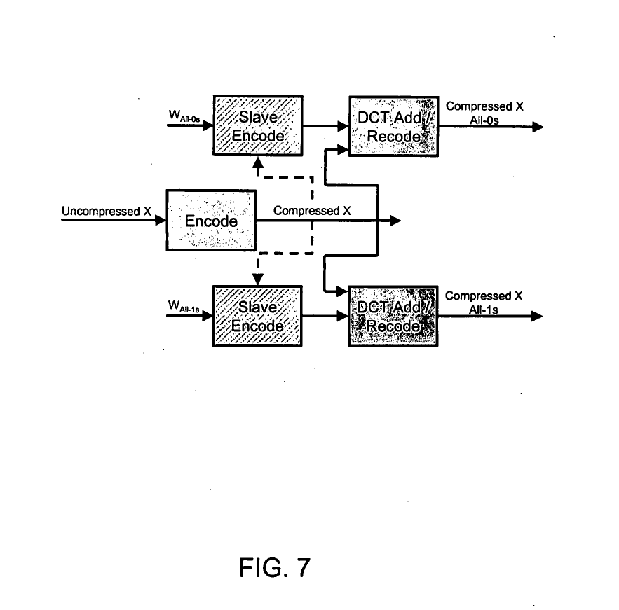

In one embodiment, the unmarked copy is compressed and the method proceeds in either of the following ways: 1) Create uncompressed all-0s and all-1s marked copies of the original sequence and run each of them through the slave encoder, to create compressed all-0s and all-1s marked copies that are compatible with the unmarked compressed copy created by the master encoder and with each other. The approach is illustrated in FIG. 6; or 2) Feed the all-0s and all-1s (uncompressed) watermark sequences to the slave encoder and then combine each of the resulting compressed watermark sequences with the compressed unmarked copy to create compressed all-0s and all-1s marked copies that are compatible with the unmarked compressed copy created by the master encoder and with each other. The approach is illustrated in FIG. 7.

Either way, in the slave-encode twice method, the resulting marked copies are compatible with each other (and with the original copy). As in the slave encode once method, compatibility can be guaranteed and the content need be encoded only once. In addition, a carrier list (i.e., a spatiotemporal list of watermark locations) need not be generated until after compression, i.e., compression is independent of watermarking, which provides operational workflow advantages.

For certain applications, it is desirable not to change the size of the compressed file upon insertion of the watermarks in the compressed domain. This size preservation may be desirable to meet bandwidth, buffering or recording medium size constraints. There are two ways to deal with this problem: 1) Leave additional space during compression (or pad the compressed file), so that the resulting bit stream is compliant with the standard but still has some “slack” space in it. When the watermark is added in the compressed domain, the slack space can be used to absorb the expansion while preserving the size of the bit stream. One way of adding slack space in an MPEG-2 bitstream is to intentionally add picture-layer stuffing, which is in an integer number of zero bytes added to the end of a coded picture. As a conservative estimate, the amount of stuffing should be greater than the largest increase that the low-frequency watermark is expected to add to the bit rate (on the order of 2-4%); or 2) Locally adjust the bit rate. The bit rate may be locally adjusted so that the total size of the compressed picture (with watermark) is less than or equal to that of the original frame. If the adjusted frame size, after requantization, is less than the original frame, it can be made equal to the original frame by picture-layer stuffing. Local adjustment of bit rate can be done in many ways and can be done in a single pass or in multiple passes for coded frame. Since the addition of the watermark will generally increase the bit rate, the way to compensate for this is to more heavily quantize certain parts of the image, compared to their original quantization state. For instance, the edges of the image or busier regions can be quantized more heavily with little degradation. When the picture is requantized, the total coded size of each watermarked frame is compared to its original. Requantizing by a single large factor (like 1.2× the original) will virtually guarantee that the output frame size will be smaller than the original in a single pass; however, the quality degradation may be too severe. In a multipass embodiment, selected regions are more heavily quantized and the output size is iteratively compared to the original until it is equal or lower in size. If desired, image and video quality tools, like peak signal-to-noise ratio (PSNR) and just noticeable difference or just noticeable distortion (JND), can be used to assess the impact of the requantization. Thresholds can be used to ensure that degradation due to requantization stays below some predetermined value.

For some applications, it may be desirable to process content frames (in order to embed the watermark) in an order different from the order in which the content frames were processed when the carrier list for the watermarks was created. For example, it may be desirable to process the content in the order in which it is stored on a physical medium, which may be different from the order in which it is played out. An example is a DVD image file, where blocks of compressed video may not be stored consecutively because of navigation or interleaving.

In step 115 the at least two content versions are alternated in order to provide uniquely marked content. In one embodiment, the original (unmarked) copy is marked twice, once with all watermark carriers modulated to carry a 0-bit as payload and once with all watermark carriers modulated to carry a 1-bit as payload. Creating an individually marked copy with an arbitrary payload essentially reduces to assembling the copy by selecting frames from the all-0 marked sequence (if the copy to be created has a 0 payload in the corresponding location) or from the all-1 marked sequence (if the copy to be created has a 1 payload in the corresponding location). This is illustrated in FIG. 2. Note that switch 205 can be either special purpose hardware or it can be a software program running on a general purpose processor. The two basic streams (all-0s and all-1s) can be provided over a network or can be stored on disk. Furthermore, the two streams can even be multiplexed/interleaved over a single stream, with the switch choosing to skip the frames it does not need (according to the payload).

In one embodiment two compressed watermarked master streams are created, one marked entirely with is and the other entirely with 0s. To create a uniquely watermarked stream from these two, the streams are selected alternately using a pattern of alternation that represents a unique code sequence.

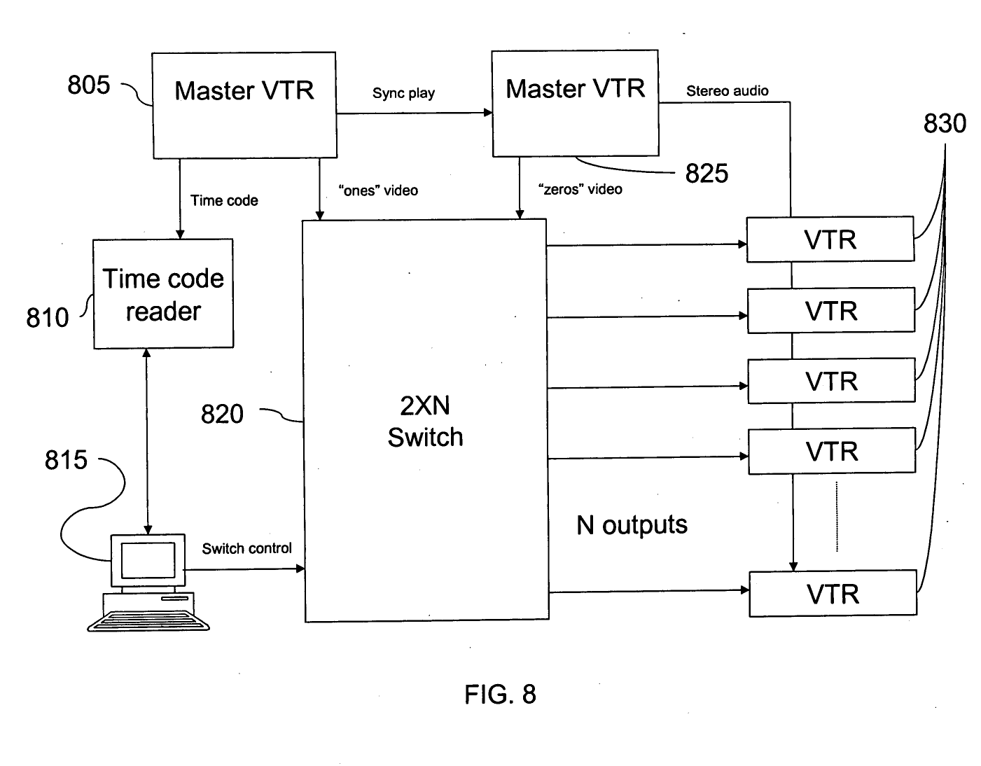

In another embodiment, two uncompressed video streams are provided, each stream marked with either an “all ones” watermark sequence or an “all zeros” watermark sequence. FIG. 8 illustrates an apparatus in accordance with one embodiment of the present invention. In one embodiment, two uncompressed video streams coming from video storage media (e.g., magnetic storage medium or optical disk). In one embodiment, two video tape recorders (VTRs) 805, 825 are provided. The two video signals are connected to respective inputs of a video router 820 that has a plurality of outputs, any of which may be connected to either of the inputs, independently of the other outputs. The video router 820 may perform a switching or mixing function. Router 820 may be implemented in software or hardware. The connection may be changed so that an output of router 820 may be switched from one input of router 820 to the other. The time of said switching operation may be directed by controller 815. Controller 815 may direct such switching operations in accordance to a sequence of 1s and 0s. Controller 815 may be responsive to time information extracted from one of the master VTRs. The outputs of router 820 may be connected to a plurality of record VTRs 830.

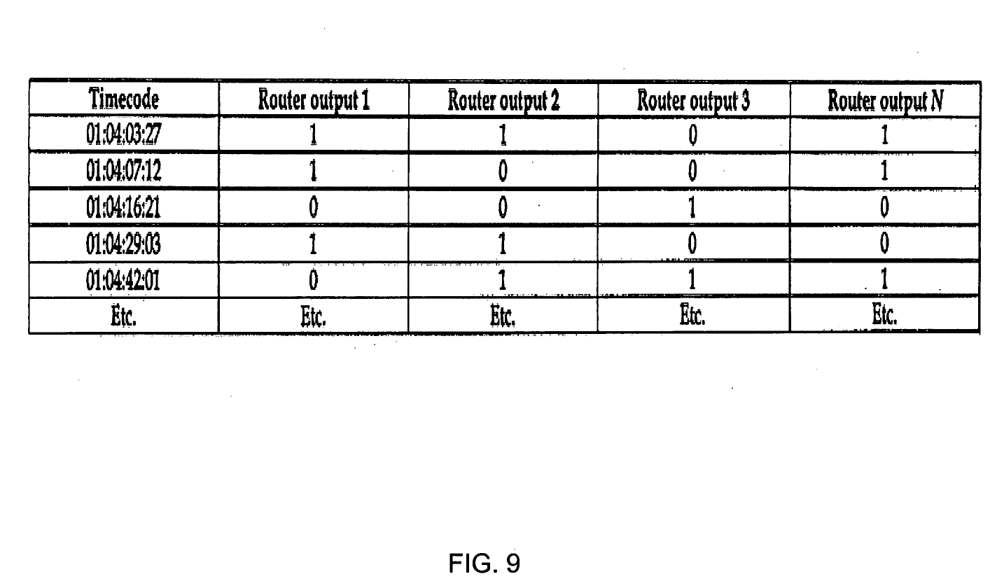

In one embodiment, two master VTRs 805, 825 playing in sync are fed to a 2×N routing switcher 820 that is remote-controlled by a PC 815 with a timecode reader 810. In one embodiment, timecoder reader 810 is a PCI timecode reader card. Timecode from one VTR 805 (or perhaps house timecode) is fed to the PC 815. PC 815 is also given a file containing a sequence of 1s and 0s unique for each of the N router outputs, corresponding to which VTR 805, 825 should be connected to a given router output, and the times (timecodes) at which those connections should be made. An example of the file PC 815 is given is illustrated in FIG. 9. PC 815 issues switch commands to 2×N routing switcher 820 in response to the timecode at its input from a master VTR 805. Audio is copied identically to all record VTRs 830, for example from one of the master VTRs 805, 825.

In one embodiment, more than two uncompressed video streams may be provided (not shown). In this embodiment each stream would be marked with either an “all ones” watermark sequence, an “all zeros” watermark sequence, or no watermark sequence. This operation may be necessary if any of the ‘one’ or ‘zero’ watermarks is visible, in which case the unwatermarked sequence would be switched in.

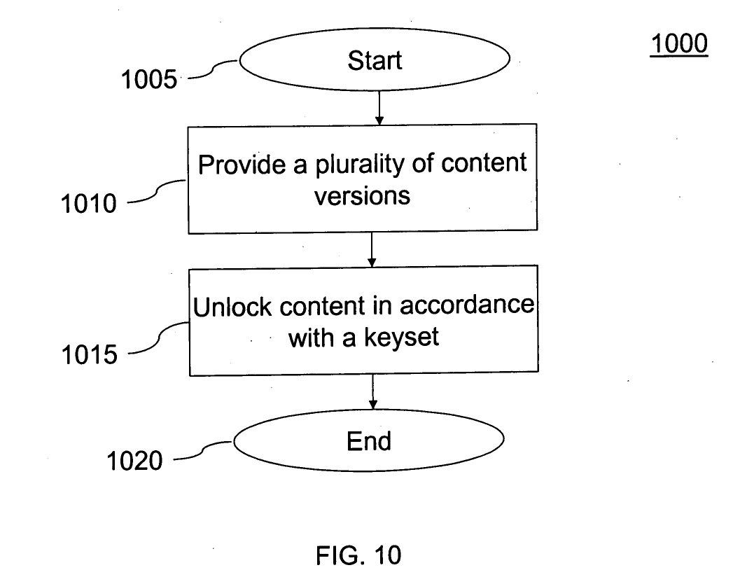

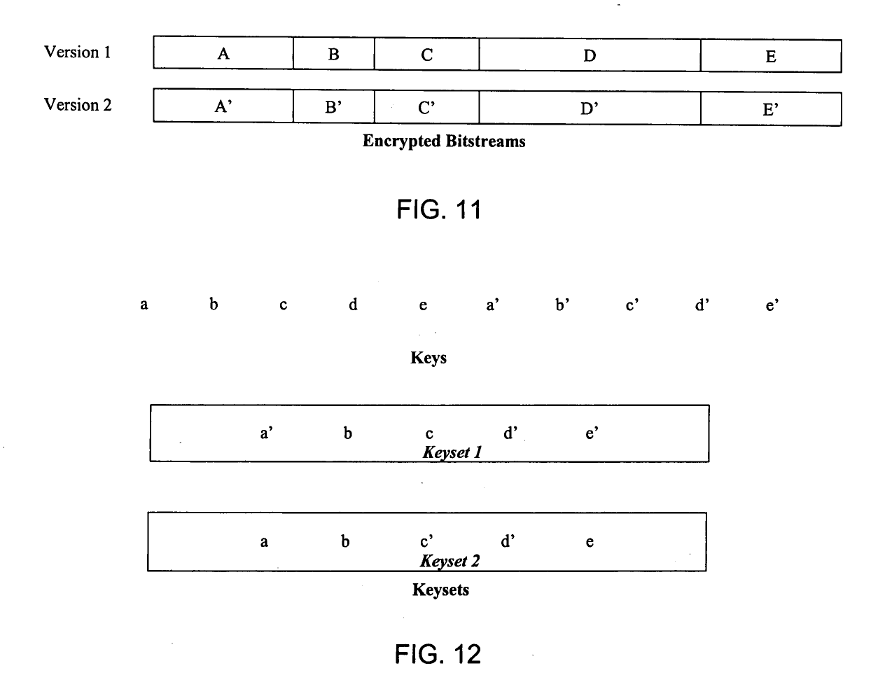

FIG. 10 illustrates a diagram in accordance with a method 1000 of the present invention. Method 1000 starts in step 1005 and proceeds to step 1010. In step 1010 a plurality of content versions are provided. In one embodiment, two content versions are provided. For d-cinema, audio, or any data, in this embodiment, two non-identical versions of the data are transmitted. Each version is segmented into the same number of segments and each segment is separately encrypted. Although the segments are similar, they may differ in various ways. For example, the segments of Version 1 may be watermarked differently from those of Version 2. FIG. 11 illustrates two versions of a bitstream with corresponding segments marked A, A′, B, B′, etc.

In step 1015 content is unlocked in accordance with a keyset. Along with the versions of the data is a set of keys, transmitted separately, that unlocks some, but not all of the segments. FIG. 12 shows all possible keys and two possible keysets. In this embodiment, key a corresponds to segment A, key a′ corresponds to segment A′, key b corresponds to segment B, etc. Although all segments are broadcast to all locations, different keysets are sent separately to each location.

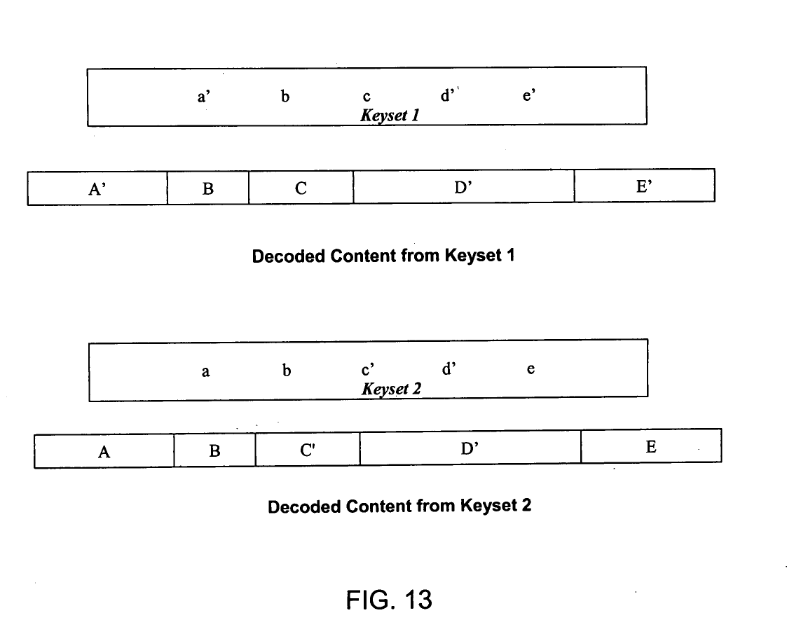

In the embodiments illustrated in FIGS. 11 and 12, a keyset unlocks (decrypts) one and only one member of each corresponding pair of segments from the two versions. The only data available for display at the receiving site is that which can be decrypted using the unique keyset sent to that site. FIG. 13 illustrates the versions produced by each keyset. Note that in this example, there are five pairs of segments, [A,A′], [B,B′], etc. This means that there could be up to 32 uniquely different copies of the data that were actually used, in, for example, a theatre for a movie. Thus, if the data set were a movie, it could be uniquely watermarked for each of 32 screens. Typically, movies are released on fewer than 10,000 screens. Thus a unique set of watermarks for each screen would require keysets with 14 segment pairs in the example used. This is because each segment pair represents a binary choice, and 2¹⁴=16,384, i.e., that many unique copies of the movie would be available using this method.

Note that the keys are sent entirely separately from the content. In order to ensure security, the keys would be sent separately from content, perhaps using public key encryption technology to securely send a keyset over the Internet to each venue where the content was to be displayed. Because the keys are very small, they can be sent efficiently to a large number of locations. Thus, using the movie example, if a movie is shown on three thousand screens, the large content files can be broadcast to all locations, but the small keyset files can be sent, individually, over the Internet to each theatre. The content owner would have a record of how and to whom that keyset was distributed. In this example, each location would have a unique keyset that would allow only the particular subset of content to be played.

If pirated content were found with a particular set of watermarks, it would be instantly clear which keyset was used on the content. In one embodiment, watermarking could be implemented using a combination of marked segments where the marked segments are marked with a watermark representing a “one” or a “zero”. In another embodiment, watermarking could be implemented using a combination of marked and unmarked segments since it may be necessary to replace a marked segment with an unmarked segment if the marked segment is visible.

In the above embodiment, the entire content comprises paired segments and it would be necessary to send twice as much content to the receiver in order to have one unique piece of content. However, for purposes of distinguishing individual versions of the content, it may not be necessary to have the entire content paired up, only small parts of it that might, for example, contain distinguishing watermarks.

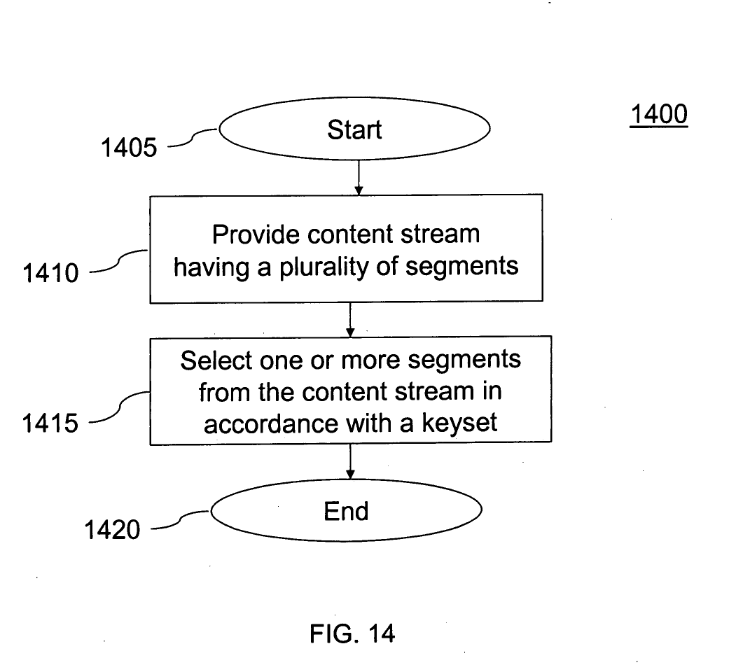

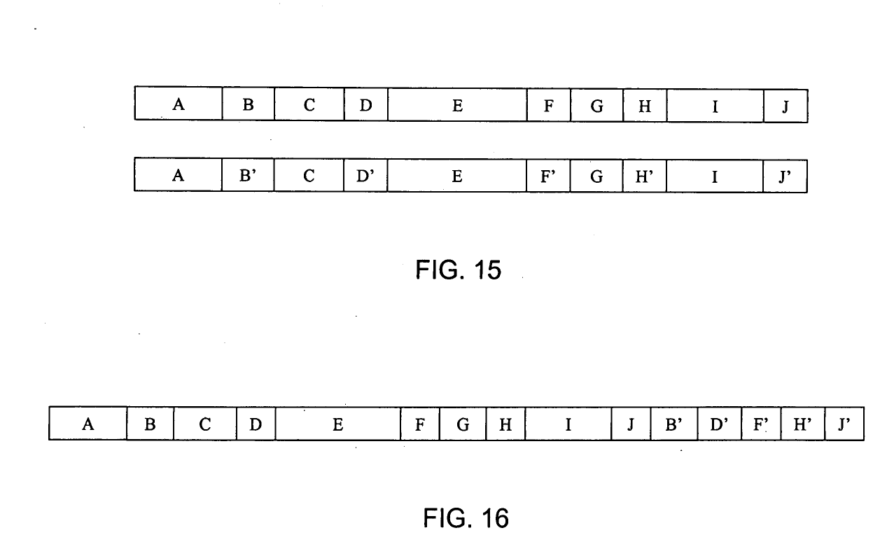

FIG. 14 illustrates a diagram in accordance with a method 1400 of the present invention. Method 1400 starts in step 1405 and proceeds to step 1410. In step 1410 a content stream having a plurality of segments is provided. In step 1415, one or more segments are selected from the content stream in accordance with a keyset. FIGS. 15 and 16 illustrate one embodiment of how method 1400 may be implemented.

The content bitstreams in FIG. 15 differ only in the [B,B′], [D,D′], [F, F′], [H, H′], and [J,J′] segments. The A, C, E, G, and I segments are identical, and make up most of the content. Note that for encryption/decryption purposes, only one key, or set of keys, is necessary to decrypt the identical segments. For example, a single key might be sufficient in all instances to decrypt A, C, E, G, and I. Rather than send two entire copies of the content, it is only necessary to send one version of A, C, E, G, and I. Alternate versions of the segments that differ can be embedded in or appended to the full version. FIG. 16 shows such a version with the alternate segments appended at the end. Alternate versions of segments may also be embedded in the content.

In one embodiment, watermarking could be implemented using a combination of marked segments where the marked segments are marked with a watermark representing a “one” or a “zero”. In another embodiment, watermarking could be implemented using a combination of marked and unmarked segments since it may be necessary to replace a marked segment with an unmarked segment if the marked segment is visible.

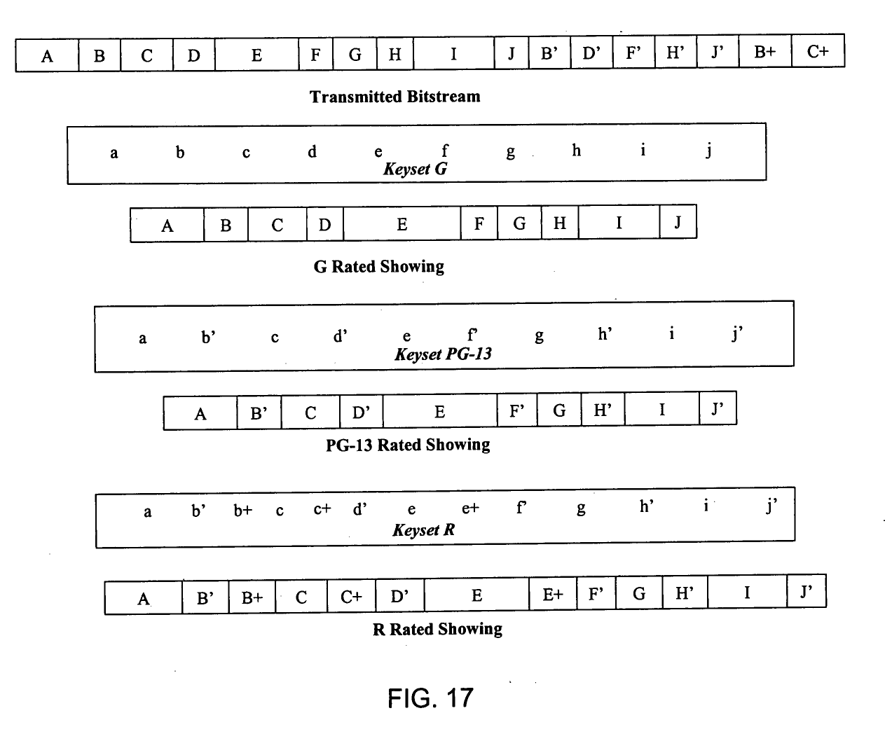

Besides watermarking, as in the previous examples, it may be useful to broadcast multiple versions of data, for example movies with different ratings. The content provider may want to send a single data stream that plays differently in different locations, e.g., with a PG-13 rating in one location and an R rating in another. This is easy to do with the proposed scheme, by only sending keys for the segments to be displayed. Note that there may be some segments that do not appear at all in some reconstructed versions of the content. A movie studio might wish to send out a movie with several different ratings and perhaps charge differently for each rating, or restrict distribution of some ratings to particular geographic areas. FIG. 17 illustrates a bitstream that contains both G and PG-13 scenes, as well as additional material that is R-rated. The segments marked B′, D′, F′, H′, J′ are PG-13 scenes while the additional ‘+’ scenes do not appear at all in the other two versions.

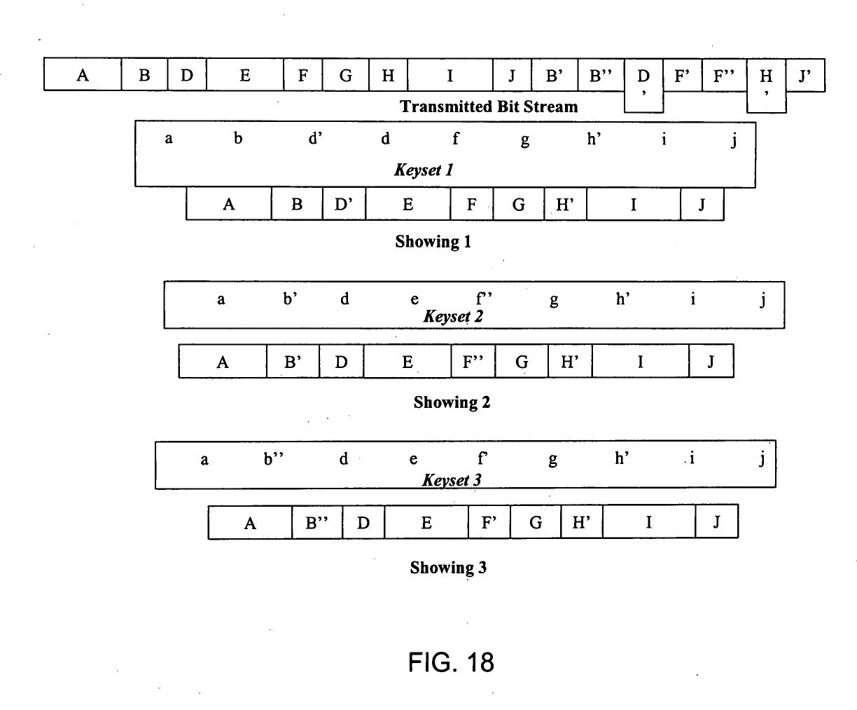

There could be more than two versions of any given piece of the content, so that keysets would be selected from more than two sets of keys. FIG. 18 illustrates a set of three versions.

Note that in FIG. 18, there are three versions of both the B and F segments and that all three can be used or other combinations and permutations can be used, depending on which set of keys is given to unlock the content. Of course, alternate versions need not be of the same length, e.g., B, B′, and B″ may contain varying amounts of content.

Different versions and different ratings and unique watermarking can all be applied simultaneously to the same content.

The present invention need not be applied only to image content. It could apply equally well to audio or other data that is broadcast to sites. For example, the content owner could control the language in which a movie is shown. From a business point of view, a distributor might want to charge more for a movie with multiple language sound tracks as opposed to a single language. The present invention allows the content owner to control which audio goes with the movie as it is shown.

The invention disclosed in FIGS. 10-18 do not simply apply to broadcasting, but to any instance where there is a desire to send identical content that can be played back uniquely. For example, the techniques described could be applied to DVDs or CDs, where many identical copies of a particular physical medium are made. Even if the software were completely known, without a keyset the DVD cannot be played, so that the system is in some sense “hack proof.” DVDs or CDs could be freely distributed and keysets could be sent to members uniquely through the Internet in encrypted form. Stolen copies would be immediately traceable to the originating DVD or CD.

The invention disclosed in FIGS. 10-18 could also be utilized to provide uniquely marked internet downloads. This can be accomplished in one of two ways: 1) Having two versions, one of all zeroes and one of all ones. When someone legitimately, after paying, downloads content (e.g., movie, song, music video) they are given a uniquely watermarked copy. If the person who downloaded the content gives the copy away or posts it illegitimately on the web, the copy can be traced back to the original, legitimate download; or 2) Allowing anyone to freely download an encrypted copy from a repository on the web, but requiring the downloader to buy a keyset in order to decrypt the downloaded copy. The use of a keyset would allow a unique decryption in accordance with the present invention. Again, if the copy were given away or posted, it would be easily traceable. By using a keyset, there is no need to create a unique version every time, only a unique (and much smaller) keyset.

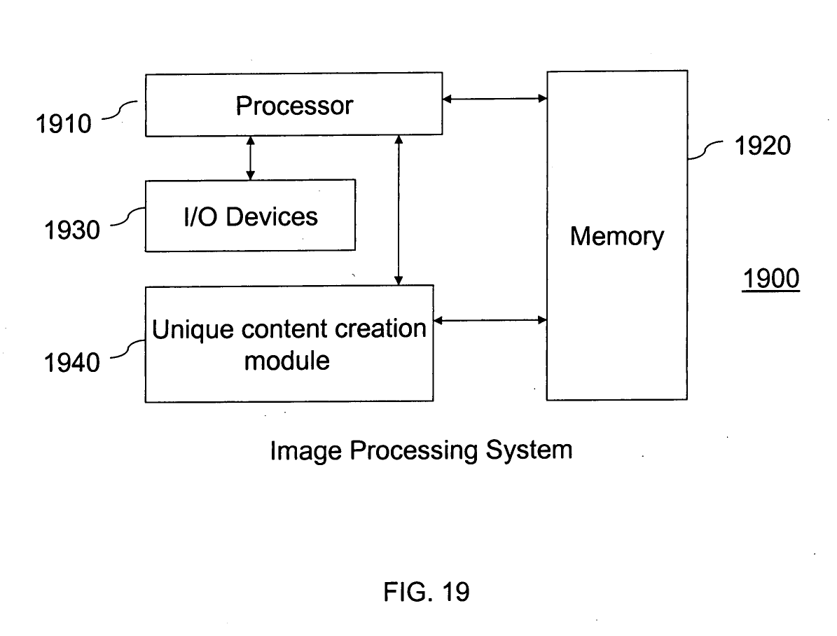

FIG. 19 illustrates a block diagram of an image processing device or system 1900 of the present invention. Specifically, the system can be employed to insert low frequency watermarks in the compressed domain. In one embodiment, the image processing device or system 1900 is implemented using a general purpose computer or any other hardware equivalents.

Thus, image processing device or system 1900 comprises a processor (CPU) 1910, a memory 1920, e.g., random access memory (RAM) and/or read only memory (ROM), unique content creation module 1940, and various input/output devices 1930, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the unique content creation module 1940 can be implemented as one or more physical devices that are coupled to the CPU 1910 through a communication channel. Alternatively, the unique content creation module 1940 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 1920 of the computer. As such, the unique content creation module 1940 (including associated data structures) of the present invention can be stored on a computer readable medium, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method of creating multiple unique copies of content, comprising:
providing at least two content versions; and
alternating the at least two content versions in order to provide uniquely marked content.

2. The method of claim 1 wherein the at least two content versions and the uniquely marked content are compressed.

3. The method of claim 1, wherein the providing step further comprises:
embedding all zeros in a first content version; and
embedding all ones in a second content version;

4. The method of claim 3, wherein the providing step further comprises:
encoding the first content version; and
encoding the second content version.

5. The method of claim 3, wherein the providing step further comprises:
encoding the first content version; and
slave encoding the second content version.

6. The method of claim 1, wherein the providing step further comprises:
embedding all zeros in a first content version;
encoding the first content version;
feeding a difference signal into a slave encoder; and
combining the slave encoded difference signal with the encoded first content version to create an encoded second content version.

7. The method of claim 6, wherein the difference signal comprises a difference between an all ones watermark sequence and an all zeros watermark sequence.

8. The method of claim 1, wherein the providing step further comprises:
encoding a first content version;
embedding all zeros in a second content version;
slave encoding the second content version;
embedding all ones in a third content version; and
slave encoding the second content version.

9. The method of claim 1, wherein the providing step further comprises:
encoding content;
slave encoding a first watermark sequence;
slave encoding a second watermark sequence;
combining the encoded content with the slave encoded first watermark sequence; and
combining the encoded content with the slave encoded second watermark sequence.

10. The method of claim 1, wherein the at least two content versions are created from uncompressed content.

11. The method of claim 10, wherein a first content version comprises an all zeros version and a second content version comprises an all ones version.

12. The method of claim 11, wherein a third content version comprises an unmarked version.

13. The method of claim 1, wherein said alternating step comprises switching among the at least two content versions in order to provide uniquely marked content.

14. The method of claim 1, wherein said alternating step comprises mixing among the at least two content versions in order to provide uniquely marked content.

15. A method of creating multiple unique copies of content, comprising:
providing a plurality of content versions, each content version comprising a plurality of corresponding segments; and
unlocking content by selecting only one of each of the corresponding segments from the plurality of content versions in accordance with a unique keyset.

16. A method of creating multiple unique copies of content, comprising:
providing a content stream having a plurality of segments, at least one of the segments having at least one corresponding segment in the content stream; and
selecting one or more segments from the content stream in accordance with a unique keyset.

17. The method of claim 16, wherein a first corresponding segment comprises content from the content stream having a first watermark and a second corresponding segment comprises content from the content stream having a second watermark.

18. The method of claim 17, wherein a third corresponding segment comprises content from the content stream without a watermark.

19. The method of claim 16, wherein the at least one corresponding segment is appended to the content stream.

20. The method of claim 16, wherein the at least one corresponding segment is embedded in the content stream.

21. An apparatus for creating multiple unique copies of content, comprising:
means for providing at least two content versions; and
means for alternating the at least two content versions in order to provide uniquely marked content.

22. An apparatus for creating multiple unique copies of content, comprising:
a plurality of synchronized master playback devices for playing a plurality of content versions;
a router having a plurality of inputs and outputs, the router configured to receive the plurality of content versions from the plurality of synchronized master playback devices and output one of the plurality of content versions at each of the plurality of outputs;
a controller for determining which of the router inputs is connected to the plurality of outputs of the router at a given time; and
a plurality of recording devices connected to the plurality of outputs of the router.

23. The apparatus of claim 22, wherein the controller is equipped with a timecode reader.

24. The apparatus of claim 23, wherein the controller reads timecode from one of the synchronized master playback devices.

25. The apparatus of claim 23, wherein the controller reads a house timecode.

26. The apparatus of claim 23, wherein the controller determines which of the router inputs is connected to each output of the router using a file.

27. The apparatus of claim 26, wherein the file comprises:
a plurality of identifier sequences, each identifier sequence corresponding to one of the plurality of outputs of the router, each identifier in the identifier sequence identifying one of the plurality of inputs of the router; and
timecodes at which routing decisions are to be made by the controller for each output of the router.

28. The apparatus of claim 27, wherein routing at each output of the router comprises switching among the plurality of inputs to the router.

29. The apparatus of claim 27, wherein routing at each output of the router comprises mixing among the plurality of inputs to the router.

30. The apparatus of claim 22, wherein an audio signal is copied identically to the plurality of recording devices.

31. A computer-readable medium having stored thereon a plurality of instructions, the plurality of instructions including instructions which, when executed by a processor, cause the processor to perform the steps of a method of creating multiple unique copies of content, comprising of:
providing at least two content versions; and
alternating the at least two content versions in order to provide uniquely marked content.
